(19) United States
(12) Patent Application Publication
(10) Pub. No.: US 2015/0120608 A1
(43) Pub. Date: Apr. 30, 2015

(54) INTERACTIVE MULTIDIMENSIONAL PORTFOLIO ANALYSIS

(71) Applicant: Lightkeeper LLC, Boston, MA (US)

(72) Inventors: Robert Leftwich, O'Connell (AU); Maki Hoashi, Forest Hills, NY (US); Danny Dias, San Francisco, CA (US); Matthew Calder, Framingham, MA (US); Larry Longo, Sudbury, MA (US); Michael Richard, New York, NY (US); Ryan Mackey, Sleepy Hollow, NY (US); William Blinn, Boston, MA (US); Steve Norton, Marlborough, MA (US); Brian Martin, Westwood, MA (US); Robert Tishman, Wellesley Hills, MA (US)

(73) Assignee: Lightkeeper LLC, Boston, MA (US)

(21) Appl. No.: 14/062,335

(22) Filed: Oct. 24, 2013

(51) Int. Cl. G06Q 40/06; G06F 3/0482

(52) U.S. Cl. CPC G06Q 40/06; G06F 3/0482
USPC 705/36 R

(57) ABSTRACT

Financial portfolios are analyzed based on a number of statistics and presented as a visualization on a display. The visualization is changeable based on user inputs, including definition by the user of a analysis period and selection of specific statistical filters. The visualization responds to the inputs substantially in real-time.

### FIELD OF THE INVENTION

The invention relates generally to the graphical presentation of data, and more specifically to methods and supporting systems for presenting statistical data in a manner that provides enhanced knowledge of a portfolio and improves operation capabilities.

### BACKGROUND

Over the past few decades, the financial industry has switched from a paper business to an almost entirely digital business. This transition has enabled participants to access more information than ever before and to perform complex calculations and analysis, all in near real-time. Further, this information can be accessed on a variety of client devices, such as personal computers, monitors, and hand-held devices that are capable of connecting with a server through one or more networks (wired, wireless, etc.).

While having access to all this information can improve a user's ability to manage a financial portfolio, it may be useless unless presented in an organized fashion. A presentation with limited entries or graphs, or without sufficient context, can inhibit a user's understanding of the information being presented. This may lead to a significant time investment by the user to parse the presented materials, or worse, incorrect assumptions or analysis. Additionally, the user may be interested in multiple statistical attributes over a given time period, and possibly over several different time periods. Typical systems for presenting such information tend to be inflexible or unwieldy, often requiring the user follow a rigid and complex process to display the desired information. What is needed is a system that facilitates visualization of financial portfolio statistics in an easily digestible form, and that provides the user with many options for manipulating the data and timeframe for the data presented.

### SUMMARY OF THE INVENTION

The invention provides methods and supporting systems for displaying visualizations of financial portfolio statistics. The display visualization is customizable by a user in a number of aspects, including the type of data presented and the timeframe against which it is presented. A number of visual cues are provided to the user to aid the understanding of the information being presented and analyzed, such as masked portions along a timeline for periods not currently under consideration. Combinations of graphical and numerical information provide a user with an assortment of understandable information in a single browser window.

In one aspect, the invention provides a method for visualizing dynamically changing financial portfolio statistical data in a web browser. The method includes generating a plurality of filter selection widgets, with each filter selection widget facilitating the filtering of the financial portfolio statistical data by a respective data facet, and collectively simultaneously filtering the financial portfolio statistical data by a collection of user-selected data facets. The method also includes generating a time scale filter for facilitating user manipulation of a screen object along a sliding scale to determine a period for the financial statistic, generating a selectable list from which one or more statistics are selected for analyzing the financial portfolio and generating, for each selected statistic, a display widget. Each display widget has at least two subdisplays, with a first subdisplay having a periodic display of portfolio statistic within the period for all assets meeting the user-selected data facets, and a second subdisplay having a display of asset positions within the portfolio horizontally sorted by asset statistic during the period.

In some embodiments, the plurality of filter selection widgets includes at least one of batting average, days to liquidate, diversification, drawdown, exposure, momentum, profit and loss, return, shares, turnover, value at risk, volatility, and volume. The user-selected data facets may be a snapshot of the financial portfolio statistic for the assets meeting the data facet during the financial period. A start date and an end date of the time scale filter may be changeable. In certain embodiments, the method also includes receiving user input to change the one or more selected statistics, thereby causing a substantially immediate update of the corresponding display widget.

In additional embodiments, an unselected period outside of the analysis period has a different appearance in the first subdisplay. The unselected period in the first subdisplay may have a partially opaque appearance, and the appearance of the unselected period may be adjusted substantially in real time with manipulation of the screen object. In some embodiments, the selectable list corresponds to the plurality of filter selection widgets. In certain embodiments, the first subdisplay may display simultaneously portfolio statistic data related to secondary statistics. The different portfolio statistic data may be displayed in a same first subdisplay window, or the different portfolio statistic data may be displayed in separate first subdisplay windows.

In still other embodiments, the first subdisplay displays portfolio statistic data in graphical form. The graphical form may be a histogram. In some embodiments, the first subdisplay and the second subdisplay display portfolio statistic data in graphical and numerical form. The first subdisplay may display a textual summary of the portfolio statistic data substantially adjacent to the graphical form.

In another aspect, the invention provides a system for visualizing dynamically changing financial portfolio statistic data in a web browser. The system includes a data communications server for storing financial portfolio statistic data and computer-executable instructions for presenting the portfolio statistic data and a processor executing the computer-executable instructions, that when executed instantiate an application for generating a plurality of features. The features include a plurality of filter selection widgets, each filter selection widget facilitating the filtering of the financial portfolio statistic data by a respective data facet, and collectively simultaneously filtering the financial portfolio, a time scale filter whereby a user manipulates a screen object along a sliding scale to determine a financial portfolio statistic period, a selectable list from which the user selects one or more statistics for measuring the financial portfolio statistic, and a statistic display widget. Each statistic display widget has at least two subdisplays, with a first subdisplay having a periodic display of portfolio statistic within the statistic period for all assets meeting the user-selected data facets, and with a second subdisplay having a display of asset positions within the portfolio horizontally sorted by asset statistic during the portfolio statistic period. The system also includes a display for graphically displaying the features.

In another aspect, the invention provides an article of manufacture having a computer-readable medium with computer-readable instructions embodied thereon for performing the methods and implementing the systems described in the preceding paragraphs. In particular, the functionality of a method of the present invention may be embedded on a computer-readable medium, such as, but not limited to, a floppy disk, a hard disk, an optical disk, a magnetic tape, a PROM, an EPROM, CD-ROM, or DVD-ROM or downloaded from a server. The functionality of the techniques may be embedded on the computer-readable medium in any number of computer-readable instructions, or languages such as, for example, FORTRAN, PASCAL, C, C++, Java, C#, Tc1, BASIC and assembly language. Further, the computer-readable instructions may, for example, be written in a script, macro, or functionally embedded in commercially available software (such as, e.g., EXCEL or VISUAL BASIC).

Other aspects and advantages of the invention will become apparent from the following drawings, detailed description, and claims, all of which illustrate the principles of the invention, by way of example only.

### BRIEF DESCRIPTION OF THE FIGURES

In the drawings, like reference characters generally refer to the same parts throughout the different views. Also, the drawings are not necessarily to scale, emphasis instead is generally being placed upon illustrating the principles of the invention.

FIG. 1 is an exemplary screen capture of a visualization of financial portfolio statistics including a plurality of filter selection widgets, a time scale filter, and a statistics display widget according to one embodiment of the invention.

FIG. 2A is an exemplary screen capture of the visualization of FIG. 1 including a selectable list of statistics according to one embodiment of the invention.

FIG. 2B is an exemplary screen capture of a visualization of financial portfolio statistic following selection of a second statistic according to one embodiment of the invention.

FIG. 3A is an exemplary screen capture of a visualization of financial portfolio statistic including a plurality of statistics according to one embodiment of the invention.

FIG. 3B is an exemplary screen capture of the visualization of FIG. 3A with an informational overlay according to one embodiment of the invention.

FIG. 3C is an exemplary screen capture of the visualization of FIG. 3A with additional statistics according to one embodiment of the invention.

FIG. 4A is an exemplary screen capture of a visualization of financial portfolio statistic in a summary view according to one embodiment of the invention.

FIG. 4B is an exemplary screen capture of a visualization of financial portfolio statistic in a dashboard view according to one embodiment of the invention.

FIG. 4C is an exemplary screen capture of a visualization of financial portfolio statistic in a grid view according to one embodiment of the invention.

FIG. 5 is an exemplary screen capture of a visualization of financial portfolio statistic with a selectable summary according to one embodiment of the invention.

FIG. 6A is a schematic representation of components used to generate and display a visualization according to one embodiment of the invention.

FIG. 6B is a schematic representation of a client device on which a visualization can be displayed and manipulated according to one embodiment of the invention.

### DETAILED DESCRIPTION

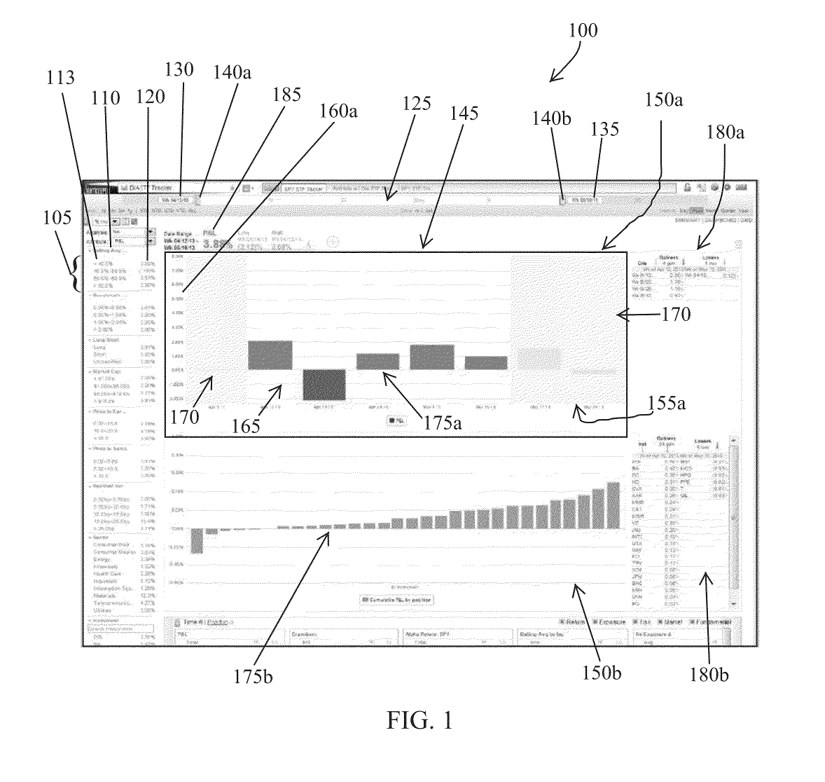

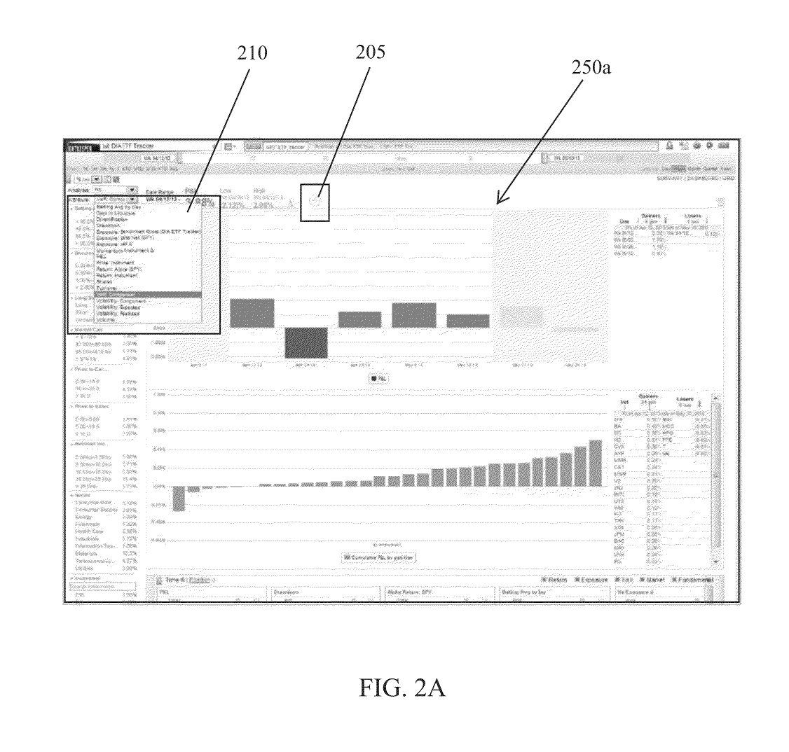

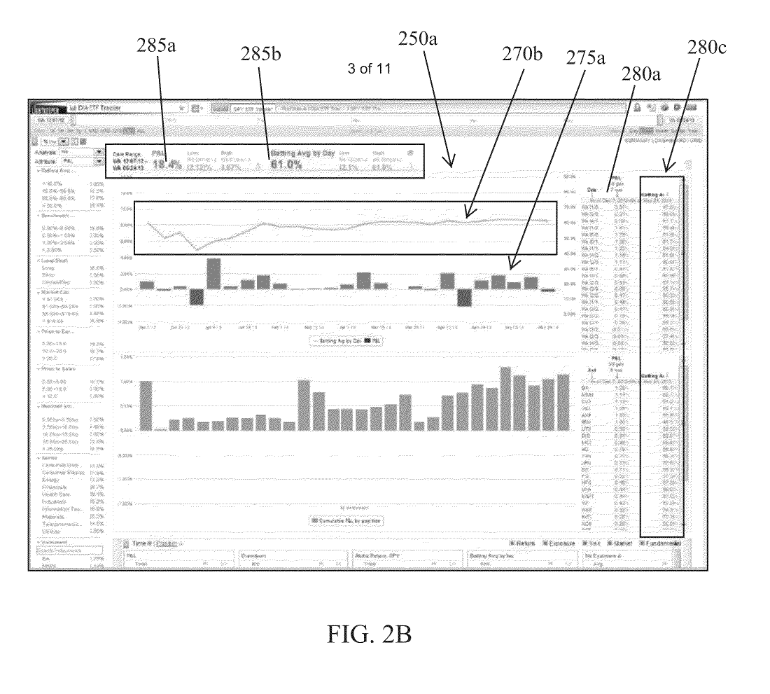

Referring to FIG. 1, the elements of a browser-based visualization 100 of dynamically changing financial portfolio data is depicted. In this case, the portfolio's return (or profit and loss) is depicted, but the visualization applies more broadly to performance, exposure, risk and market metrics. These are collectively called financial portfolio statistics. The visualization 100 includes several filter selection widgets 105. The filter selection widgets 105 are differentiated based on a related data facet 110 that may be of interest to a user, through which one or more financial portfolio metrics may be filtered. The data facets 110 can be any portfolio statistic (or attribute), including batting average (the average number of investments that were profitable), benchmark performance (the performance relative to a benchmark), days to liquidate (the number of days to liquidate the portfolio's investments under an assumption of a volume participation rate and a residual portfolio), diversification (a measure of how diversified an investment is from an index), drawdown (difference between peak earning and current earnings with a maximum value of zero), exposure (the market based exposure), days held (the number of days an investment has been held), market capitalization (the underlying investment's market capitalization which could be undefined), momentum (the ranked state of the underlying index to be directional), price to earnings, price to sales, realized volume, profit and loss, shares, turnover, value at risk, volatility, volume, etc. The data facets 110 can be categorical attributes related to portfolios, including invested sectors, geographies, topics, analysts, etc. Data facets 110 can be decomposed into data facet components 115. For example, when the data facet 110 is separable by quantifiable values (e.g., measuring price to earnings), the data facet components 115 may include ranges of values (e.g., 0.00˜10.0, 10.0˜20.0, and >20.0). A user can select a portfolio statistic of interest from a selectable list (an exemplary selectable list is depicted in FIG. 2A at 210). The entries on the selectable list can substantially correspond to the filter selection widgets 105, or the list can have additional or fewer entries than the filter selection widgets 105 visible in the visualization 100. Selecting a portfolio statistic of interest at 210 includes a contribution metric 120 for each data facet component 115 that reflects the contribution of that component to the total portfolio metric. The user selection of a data facet component 115 is described in greater detail below. FIG. 1 depicts numerous data facets 110 and user-selected data facets 115 on the left-hand side of the browser window, but the visualization 100 is not limited to those depicted, nor is it limited to the positions depicted.

A time scale filter 125 is generated as part of the visualization 100 to provide the user a means for designating the financial portfolio statistic period (i.e., the period of time over which the portfolio statistic is to be analyzed). A start date 130 and an end date 135 on the time scale filter 125, signifying the start and end of the statistic period, are changeable through a variety of user inputs. For example, a user may slide a slider 140 at either end of the time scale filter 125, with adjustment of the left slider 140a changing the start date 130 and adjustment of the right slider 140b changing the end date 135. A user may also enter dates directly into the time scale filter 125, or select dates from a calendar (e.g., a calendar that appears when hovering a cursor over the current date). Adjustment of the analysis period results in substantially immediate updates to other elements dependent upon the bounds of the period, such as the statistic snapshot 120. Appearance of a statistic display widget 145, as described in greater detail below, may also be adjusted based on the changed analysis period.

The statistic display widget 145 can have multiple displays, depicted in FIG. 1 as a first subdisplay 150a and a second subdisplay 150b. The first subdisplay 150a in the depicted embodiment provides a periodic display histogram of portfolio statistic within the statistic period for all assets meeting the user-selected data facets 115. The statistic data is depicted along an x-axis 155a with an absolute start and end consistent with those of the time scale filter 125, while the financial portfolio statistic data is graphed along a y-axis 160a. When the start date 140a and the end date 140b are changed from the absolute start and end (thereby creating an analysis period 165 and an unselected period 170 displayed beyond the analysis period 165) the appearance of a portion of the first subdisplay 150a corresponding to the unselected period 170 is different from the appearance of the portion of the first subdisplay 150a corresponding to the analysis period 165. In FIG. 1, the appearance of the first subdisplay 150a in the area corresponding to the unselected period 170 is partially opaque (or masked), such that the statistic results are visible behind a darkened region. Other methods may be used to distinguish between the analysis period 165 and the unselected period 170, such as with different shading or use of a different background color.

The adjustment in appearance of the first subdisplay 150a may be made substantially in real time with manipulation of the time filter scale 125 (through whatever means it is being manipulated). Other aspects of the statistic display widget 145 may also be substantially immediately updated based on a user input. For example, when a user changes one or more data facets, the corresponding statistic display widget 145 changes the presented data set. Such immediate response helps the user quickly view various sets of information, and also provides the user visual feedback that they are looking at the desired analysis period 165.

The minimum, maximum, and scale of the axes 155a, 160a may change depending on the statistic and the values depicted. In some embodiments, the scales, maximums, minimums and/or the segmentation of the axes 155a, 160a are automatically determined, whereas in other cases one or more of the axis parameters may be manually set and adjusted.

The financial portfolio statistic data is depicted in a graphical form 175a (e.g., a histogram) to convey the information in a form the user can quickly and easily comprehend. Many varying graphical forms are contemplated, including plotted points and line graphs, along with other known graphing techniques. The financial portfolio statistic data may be depicted in numerical form 180a adjacent the graphical form 175a, and separated into an easily comprehensible form for the user. In FIG. 1, the results 180a are separated into columns based on whether there was a positive or negative outcome for a given week. This, or other information, related to a particular timeframe depicted in the graph (e.g., a specific week in FIG. 1) may be visible by hovering a cursor over or clicking on the corresponding graph element in the first subdisplay 150a. An overall statistic result 185 for the analysis period for a particular statistic can be depicted proximate the first subdisplay 150a.

The second subdisplay 150b in FIG. 1 depicts the asset positions within the portfolio horizontally sorted along an x-axis 155b based on asset statistic (depicted in a graph 175b with values along a y-axis 160b) during the portfolio statistic period on an asset by asset basis. In this particular embodiment, the worst performing positions, according to the selected statistic, are displayed on the left. The instrument statistic increases while moving to the right, with the best performing instrument depicted in the rightmost position. The symbols for the instruments and their statistic over the analysis period may be placed adjacent to the graph (e.g., in table 180b), and can be arranged similarly to the arrangement based on time (e.g., separated by gainers and losers). This and other information may also be revealed when hovering a cursor over or clicking on a specific entry on the graph 175b, similar to the process described with respect to the first subdisplay 150a. Alternative methods can be used to arrange the graph 175b and numbers 180b, including alphabetically by instrument symbol.

A benefit of the visualization 100 is the ability to update the statistic display widget 145 substantially immediately based on a user input. For example, when a user changes one or more data facets, the corresponding statistic display widget 145 will change the presented data set. When the time scale filter 125 is adjusted, the first subdisplay 150a will change in appearance to reflect the newly defined analysis period. Such immediate response helps the user quickly view various sets of information, and also provides the user visual feedback that they are looking at the desired timeframe.

FIGS. 2A and 2B depict a process for simultaneously displaying portfolio statistic data related to different statistics or attributes in a first subdisplay 250a. The user can add additional data by selecting an icon 205, such as the plus sign indicating expansion adjacent a first subdisplay 250a in FIG. 2A. The particular statistic to be displayed can then be selected from a selectable list 210. As previously detailed, the list 210 may include the same, more, or fewer entries than the visible filter selection widgets 105. Once the statistic is selected, the first subdisplay 250a will update substantially automatically with financial statistic data related to the newly selected statistic in a second graph 270b. In FIG. 2B, both data sets are graphed in the same first subdisplay window. As will be described later, different subdisplay windows may be used to depict different statistics. An overall statistic value 285b for the newly selected statistic may also be shown adjacent an existing primary statistic 285a, and numerical values 280c for the newly selected statistic may be displayed adjacent numbers for the primary statistic numbers 280a.

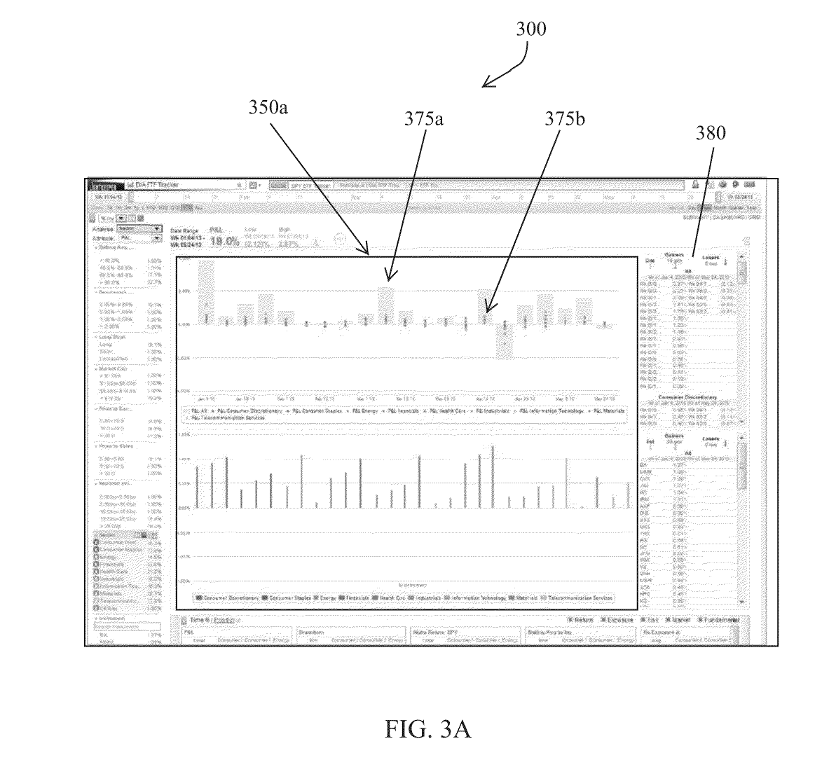

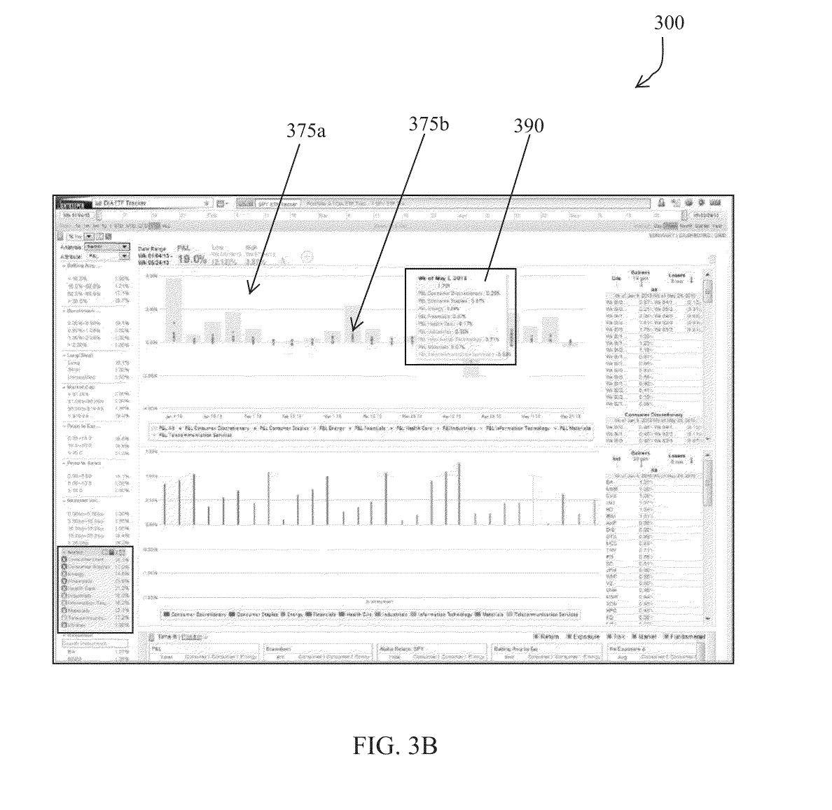

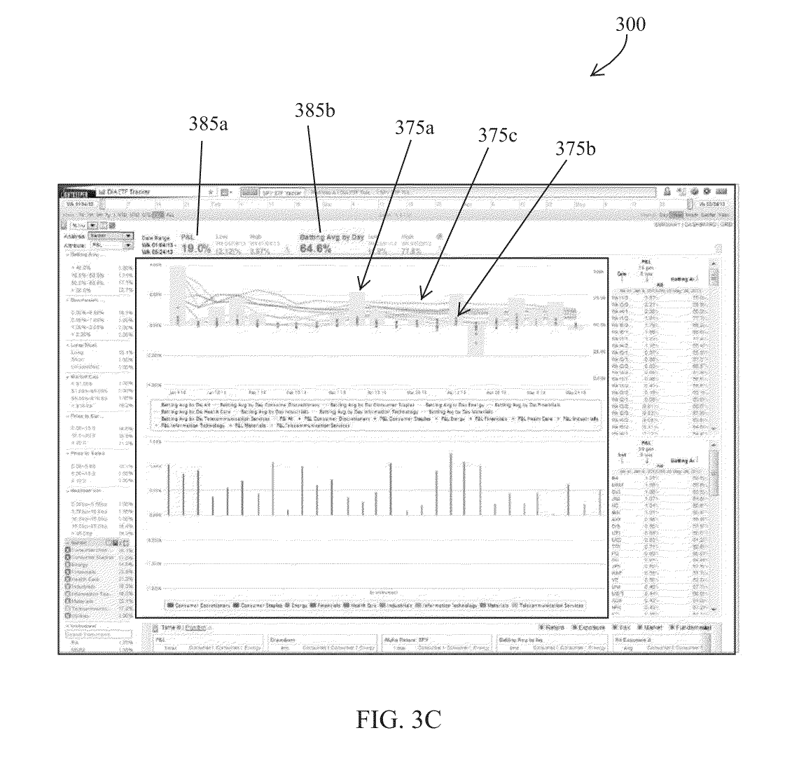

FIGS. 3A to 3C illustrate the amount and variety of information that may be depicted in a single visualization 300. In FIG. 3A, several of the components that make up visualization 300 are common with the visualizations 100, 200 and will not be described again here in great detail. In visualization 300, the financial portfolio statistic, in this case performance, is being filtered by sector (an additional “analysis” option) based on the profit and loss filter selection widget 105. In this particular embodiment, each histogram column 375a in the first subdisplay 350a depicts the total profit and loss across all sectors, while the performance of each individual sector is depicted as a plotted point 375b. FIG. 3B depicts an information overlay 390 displaying information related to a specific week, which is accessible by hovering over or clicking on a specific entry on the graph 375a. The numerical information 380 to the right of the graphs 375a, 375b is broken into separate categories, including overall and sector-by-sector performance, with performance in each category detailed by week. FIG. 3C displays additional information in the form of plotted points 375c for the daily batting average for each sector for each day in the analysis period. The visualization 300 illustrates the breadth of information that can be simultaneously presented to the user in many embodiments, while giving the user great flexibility in determining what to view.

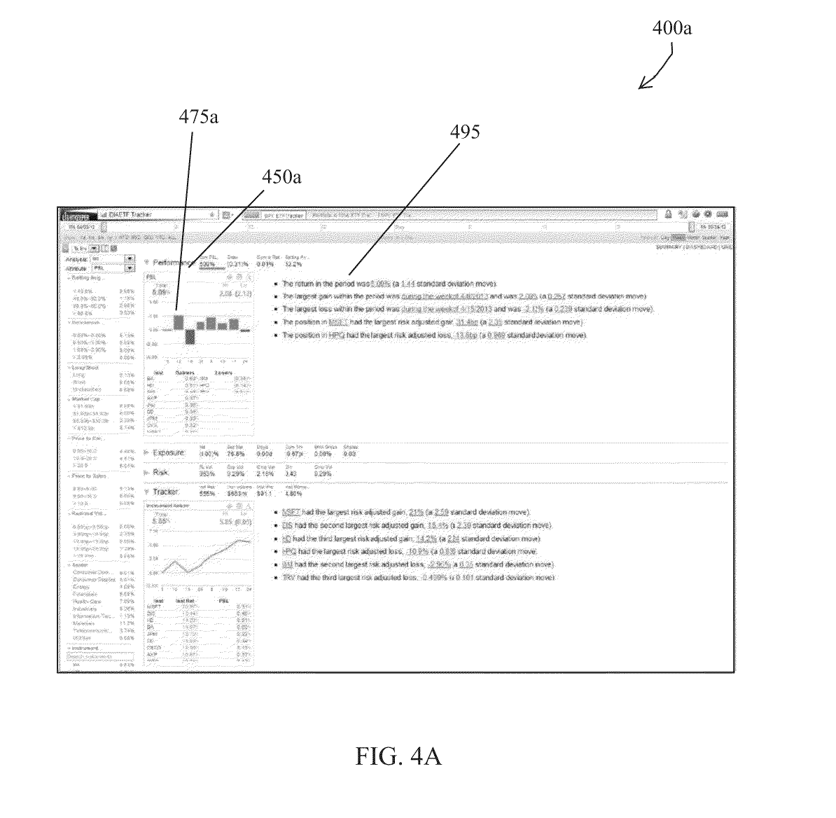

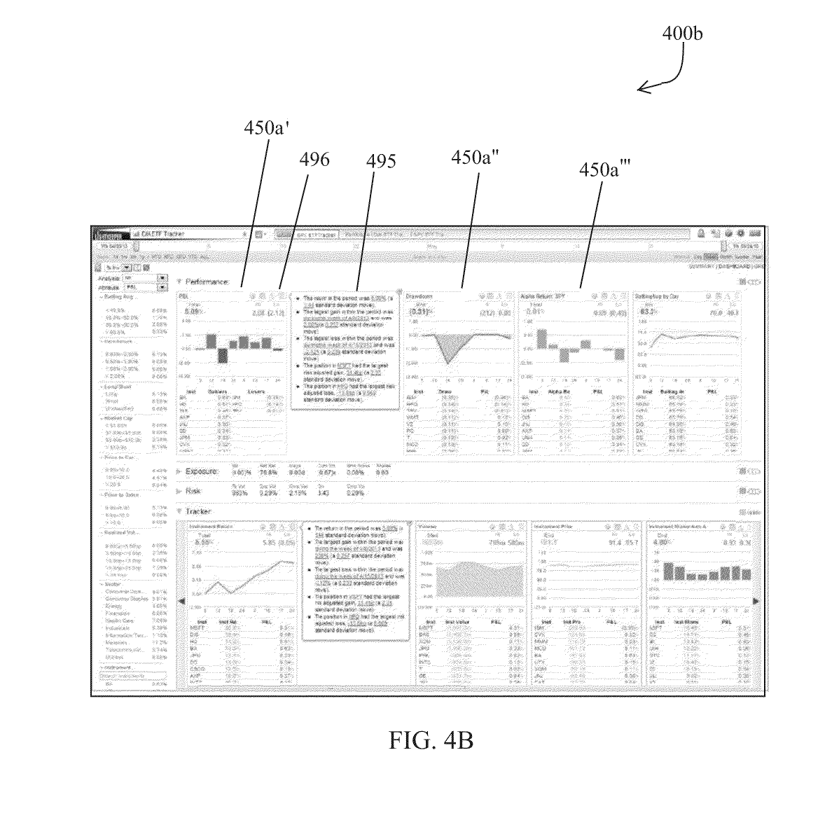

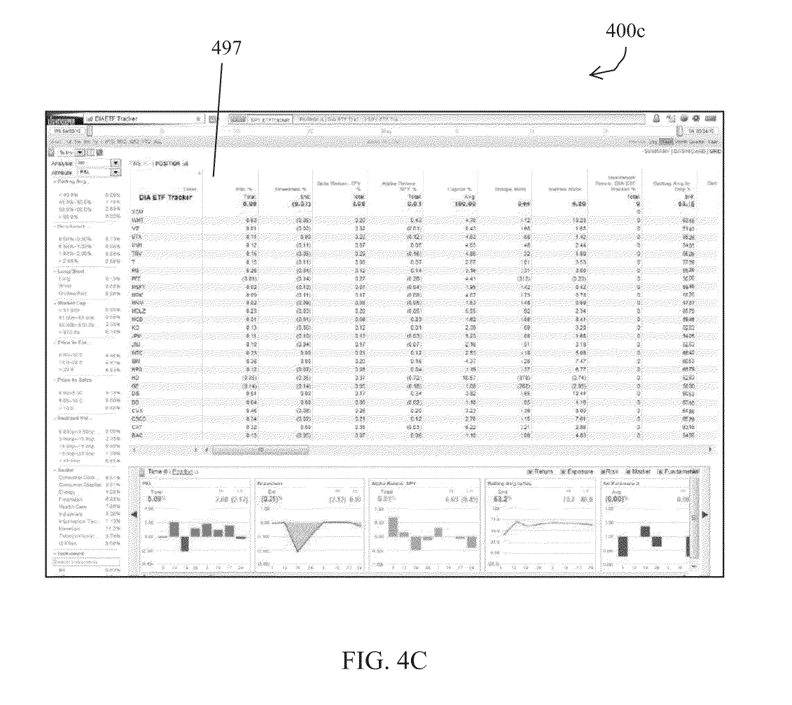

FIGS. 4A to 4C depict other embodiments with different visualizations: a summary view 400a, a dashboard view 400b, and a grid view 400c. Each of the visualizations 400a, 400b, 400c has similar aspects as the previously described visualizations 100, 200, 300, as can be appreciated based on views and icons amongst the figures. A user can swap between the different views 400a, 400b, 400c using the designated inputs on the visualization. The summary view 400a and the dashboard view 400b each display a textual summary 495 of the portfolio statistic substantially adjacent a graphical form 475a. A textual summary 495 complements the other presented information to detail certain aspects of portfolio statistic over the analysis period. The textual summary 495 describes various results for the selected statistics over the defined period, including averages, outliers, results at the high/low end, and other characteristics. The summary view 400a and the dashboard view 400b are also sectioned into performance, exposure, trade, risk, and public sections, each of which is expandable or collapsible depending on the user's desired focus.

The dashboard view 400b displays information in a similar manner as the summary view 400a, but instead of presenting one graph for a single statistic, the dashboard view 400b has multiple subdisplay windows 450a′, 450a″, 450a′″ (etc.), each displaying a graph for a separate statistic. The textual summary 495 may be viewed for each of these by selecting a commentary icon 496. The grid view 400c displays numerical results in a grid 497 having all, or substantially all, of the statistics for the financial time period. Related graphs may be provided below the grid 497.

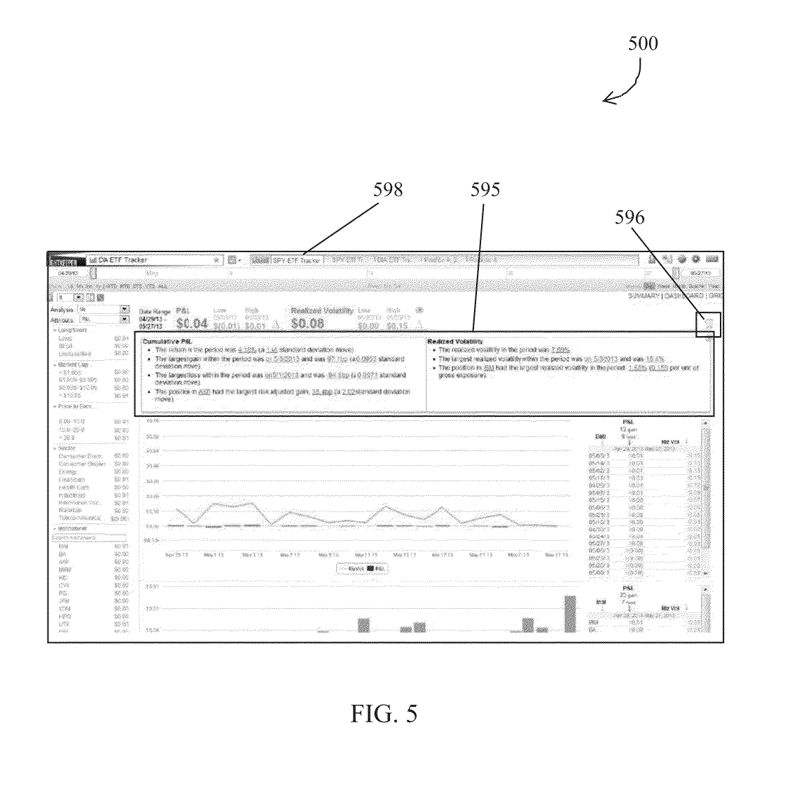

FIG. 5 depicts a visualization 500 with many of the features previously discussed. A textual summary 595 is opened by selecting a commentary icon 596. The textual summary 595 provides commentary for each of the statistics that have been selected. The visualizations are also able to generate the same displays for a reference portfolio selectable from a reference portfolio menu 398. The reference portfolios may be an industry standard, such as the SPDR S&P 500 ETF (SPY ETF) or the SPDR Dow Jones Industrial Average ETF (DIA ETF), or from a custom portfolio stored in the system. The reference portfolio data may be displayed the same as any other portfolio, and multiple portfolios may be displayed simultaneously.

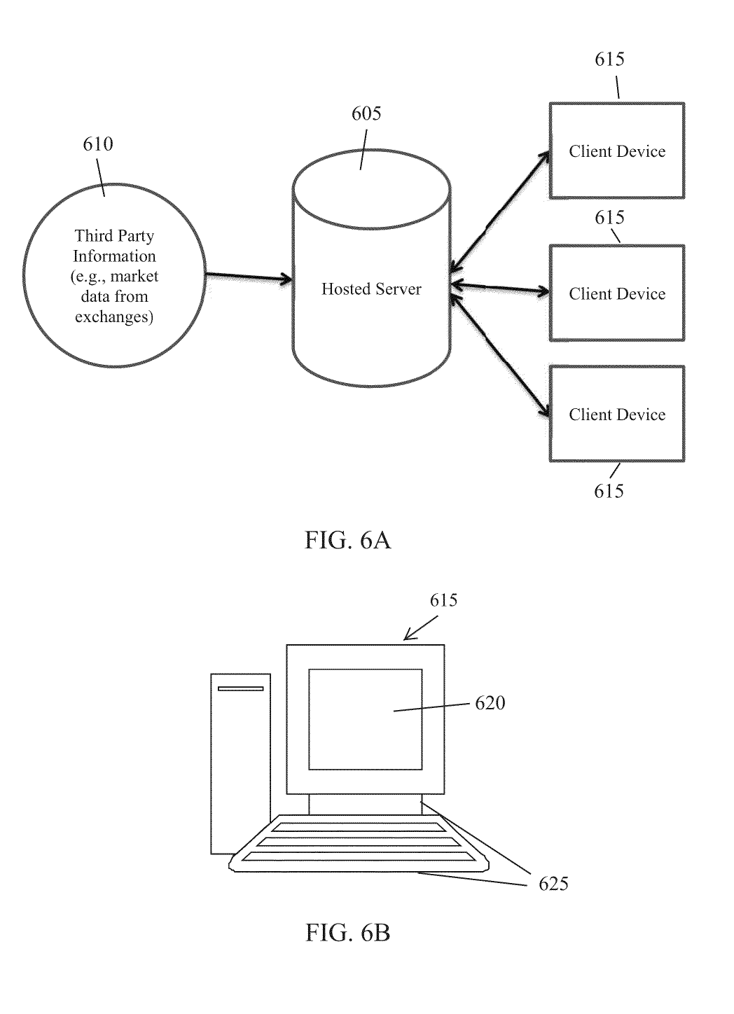

Referring to FIGS. 6A and 6B, the visualizations described above may be implemented on one or more hardware devices comprising sufficient memory and processing resources. For example, the visualizations and associated processes may each be implemented as functional modules being executed on one or more servers 605 that provide the computational functionality for executing computer-executable instructions, that when executed instantiate an application for generating a plurality of features, as described above. Computer-executable instructions may be in many forms, such as program modules, executed by one or more computers or other devices. Generally, program modules include routines, programs, objects, components, data structures, etc. that perform particular tasks or implement particular abstract data types. Typically the functionality of the program modules may be combined or distributed as desired in various embodiments. An exemplary server comprises hardware CPU(s), operatively connected to hardware/physical memory and input/output (UO) interface. Hardware/physical memory may include volatile and/or non-volatile memory. The memory may store one or more instructions to program the CPU to perform any of the functions described herein. The memory may also store one or more application programs. Separate data storage server(s) may also be used to store client information, financial portfolio information and account information.

The server 605 is configured to be updated from third party sources 610 with information related to financial portfolio statistic. In many instances, the information obtained from the third party sources 610 is related to statistic of specific assets that make up a financial portfolio. This information can be obtained from exchanges where such instruments are traded, or from other sources having updated information. One or more client devices 615 (e.g., a hand-held device, laptop, personal computer, or larger computer such as a workstation with multiple multiprocessors) can access the server to display the visualization on a client device display 620 (see FIG. 6B). In certain circumstances, resources of the client device 615 may be used in generating the visualization, including when the visualization is manipulated. A user can interact with the visualization through an input device 625, such as a keyboard, a trackball, and/or a two or three-button mouse. The user can interact with the visualization itself, as previously described, or can provide information related to the financial portfolio (e.g., position data on assets held, time of acquisition, cost at acquisition, etc.) to the server 605. One skilled in the art of computer systems will understand that the present example embodiments are not limited to any particular class or model of computer employed for the client device 615 and will be able to select an appropriate system.

The application components described throughout the specification can be implemented in whole or in part as a software program using any suitable programming language or languages (C++, C#, java, LISP, BASIC, PERL, Flash, etc.) and/or as a hardware device (e.g., ASIC, FPGA, processor, memory, storage and the like).

One skilled in the art will realize the invention may be embodied in other specific forms without departing from the spirit or essential characteristics thereof. The foregoing embodiments are therefore to be considered in all respects illustrative rather than limiting of the invention described herein. Scope of the invention is thus indicated by the appended claims, rather than by the foregoing description, and all changes that come within the meaning and range of equivalency of the claims are therefore intended to be embraced therein.

What is claimed is:

1. A method for visualizing dynamically changing financial portfolio statistical data in a web browser, the method comprising:
generating a plurality of filter selection widgets, each filter selection widget facilitating the filtering of the financial portfolio statistical data by a respective data facet, and collectively simultaneously filtering the financial portfolio statistical data by a collection of user-selected data facets;
generating a time scale filter for facilitating user manipulation of a screen object along a sliding scale to determine a period for the financial statistic;
generating a selectable list from which one or more statistics are selected for analyzing the financial portfolio;
generating, for each selected statistic, a display widget, each display widget comprising at least two subdisplays, wherein a first subdisplay comprises a periodic display of portfolio statistic within the period for all assets meeting the user-selected data facets, and wherein a second subdisplay comprises a display of asset positions within the portfolio horizontally sorted by asset statistic during the period.

2. The method of claim 1 wherein the plurality of filter selection widgets comprises at least one of batting average, days to liquidate, diversification, drawdown, exposure, momentum, profit and loss, return, shares, turnover, value at risk, volatility, and volume.

3. The method of claim 1 wherein the user-selected data facets comprise a snapshot of the financial portfolio statistic for the assets meeting the data facet during the period.

4. The method of claim 1 wherein a start date and an end date of the time scale filter are changeable.

5. The method of claim 1 further comprising receiving user input to change the one or more selected statistics, thereby causing a substantially immediate update of the corresponding display widget.

6. The method of claim 1 wherein an unselected period outside of the analysis period comprises a different appearance in the first subdisplay.

7. The method of claim 6 wherein the unselected period in the first subdisplay comprises a partially opaque appearance.

8. The method of claim 6 wherein the appearance of the unselected period is adjusted substantially in real time with manipulation of the screen object.

9. The method of claim 1 wherein the selectable list corresponds to the plurality of filter selection widgets.

10. The method of claim 1 wherein the first subdisplay displays simultaneously portfolio statistic data related to secondary statistics.

11. The method of claim 10 wherein the different portfolio statistic data are displayed in a same first subdisplay window.

12. The method of claim 10 wherein the different portfolio statistic data are displayed in separate first subdisplay windows.

13. The method of claim 1 wherein the first subdisplay displays portfolio statistic data in graphical form.

14. The method of claim 13 wherein the graphical form comprises a histogram.

15. The method of claim 13 wherein the first subdisplay and the second subdisplay display portfolio statistic data in graphical and numerical form.

16. The method of claim 13 wherein the first subdisplay displays a textual summary of the portfolio statistic data substantially adjacent to the graphical form.

17. A system for visualizing dynamically changing financial portfolio statistic data in a web browser, the system comprising:
(i) a data communications server for storing financial portfolio statistic data and computer-executable instructions for presenting the portfolio statistic data;
(ii) a processor executing the computer-executable instructions, that when executed instantiate an application for generating a plurality of features, the features comprising:
(a) a plurality of filter selection widgets, each filter selection widget facilitating the filtering of the financial portfolio statistic data by a respective data facet, and collectively simultaneously filtering the financial portfolio;
(b) a time scale filter whereby a user manipulates a screen object along a sliding scale to determine a financial portfolio statistic period;
(c) a selectable list from which the user selects one or more statistics for measuring the financial portfolio statistic; and
(d) a statistic display widget, each statistic display widget comprising at least two subdisplays, wherein a first subdisplay comprises a periodic display of portfolio statistic within the statistic period for all assets meeting the user-selected data facets, and wherein a second subdisplay comprises a display of asset positions within the portfolio horizontally sorted by asset statistic during the portfolio statistic period; and
(iii) a display for graphically displaying the features.
